(19) United States
(12) Patent Application Publication
(10) Pub. No.: US 2013/0234440 A1
(43) Pub. Date: Sep. 12, 2013

(54) SEA WAVE POWER GENERATION EQUIPMENT

(71) Applicant: Meng-Chyang Peng, Taipei City (TW)

(72) Inventor: Meng-Chyang Peng, Taipei City (TW)

(21) Appl. No.: 13/787,105

(22) Filed: Mar. 6, 2013

(30) Foreign Application Priority Data
Mar. 7, 2012 (TW) 101107688

(51) Int. Cl. F03B 13/16

(52) U.S. Cl. CPC F03B 13/16
USPC 290/53

(57) ABSTRACT

A sea wave power generation equipment includes a floating body, a frame, a plurality of rotating shafts, a plurality of first gear wheels, at least one fixing base, a generator, a transmission shaft, a plurality of second gear wheels, a plurality of collision boards, and a plurality of ratchet structures. Each of the collision boards includes a rotation portion and a board body. Each of the ratchet structures includes a pawl portion and a ratchet portion including a plurality of teeth. When the board bodies are collided with a sea wave in a direction, each of the pawl portions hooks one of the teeth of one of the ratchet portions. When the board bodies are collided with another sea wave in another direction reverse to the direction, each of the pawl portions slides a portion of the teeth of one of the ratchet portions.

### RELATED APPLICATIONS

This application claims priority to Taiwan Application Serial Number 101107688, filed Mar. 7, 2012, which is herein incorporated by reference.

### BACKGROUND

1. Technical Field

The present disclosure relates to a power generation equipment, and more particularly to a sea wave power generation equipment.

2. Description of Related Art

Since the global warming and limited petroleum reserves, the renewable energy which is environmental-friendly has been growing vigorously, such as the solar power generation, the wind power generation, the geothermal power generation, and the sea wave power generation. Because the ocean has two-thirds of the earth surface, the sea wave power generation is inexhaustible. Moreover, the kinetic energy of the sea wave is stable and relatively accessible. Therefore, there are many countries regarding the sea wave as an active development renewable energy.

The sea wave power generation is a renewable energy utilizing the kinetic energy which is formed from the sea wave. The process of generating the sea wave power is significantly clean and safe. For island countries, since the whole country is surrounded by the ocean, the sea wave power generation equipment is worth being developed and deployed. If a country can utilize the sea wave to generate power efficiently, the fraction of the thermal and the nuclear power generation can be reduced. When the requirements of the nonrenewable energies, such as coal, petroleum, or uranium, are reduced, the air pollution decreases, and so does the nuclear waste, such that the ecological environment is protected. Furthermore, compared with the sea wave power generation and the solar power generation, in that the sea wave power generation does not need the sunlight, the sea wave power generation can generate electrical power day and night continuously.

There are different types of sea wave power generation equipments with more or less disadvantages, such as expensive prices, complicated structures, and difficulty for setting. For example, some of the sea wave power generation equipments need to be fixed on the sea floor, operators need to dive into water to assemble or repair the sea wave power generation equipments. As a result, not only the labor cost is increased, but also the sea wave power generation equipments are repaired difficultly when the climate is bad.

### SUMMARY

An aspect of the present invention is to provide a heat dissipation structure.

In an embodiment of the present invention, a sea wave power generation equipment includes a floating body, a frame, a plurality of rotating shafts, a plurality of first gear wheels, at least one fixing base, a generator, a transmission shaft, a plurality of second gear wheels, a plurality of collision boards, and a plurality of ratchet structures. The floating body floats on a sea surface. The frame is fixed on the floating body and includes a hollow portion, a first side, and a second side parallel to the first side. The hollow portion is above the sea surface. Each of the rotating shafts includes a first end portion and a second end portion, and the first end portion is rotatably connected to the first side, and the second end portion is rotatably connected to the second side. The first gear wheels are respectively fixed on the first end portions. The fixing support is located on the floating body. The generator is located on the floating body. The transmission shaft is rotatably connected to the fixing support and the generator. The second gear wheels are fixed on the transmission shaft, and each of the second gear wheels is coupled to one of the first gear wheels. The collision boards are located in the hollow portion, and each of the collision boards includes a rotation portion and a board body. The rotation portion is rotatably sleeved on one of the rotating shafts. The board body is fixed on the rotation portion, and a portion of the board body is located under the sea surface. Each of the ratchet structures includes a pawl portion and a ratchet portion. The pawl portion is located on one of the rotation portions. The ratchet portion is fixed on one of the rotating shafts and adjacent to one of the rotation portions. The ratchet portion includes a plurality of teeth coupled to the pawl portion. When the board bodies are collided with a sea wave in a direction, each of the pawl portions hooks one of the teeth of one of the ratchet portions, such that the respective rotating shafts are correspondingly rotated with the respective ratchet portions. The transmission shaft is rotated by the first gear wheels and the second gear wheels, such that the generator generates electrical power. When the board bodies are collided with another sea wave in another direction reverse to the direction, each of the pawl portions slides a portion of the teeth of one of the ratchet portions, such that the rotating shafts do not respectively rotated with the ratchet portions.

In an embodiment of the present invention, the rotation portion includes two parallel protruding portions for clamping the board body.

In an embodiment of the present invention, each of the two protruding portions includes a first fixing hole. Each of the board bodies includes a second fixing hole. The two first fixing holes are aligned with the second fixing hole. Each of the collision boards further includes at least one fixing element coupled to the two first fixing holes and the second fixing hole, such that each of the board bodies is fixed between the two protruding portions.

In an embodiment of the present invention, each of the fixing elements includes a screw.

In an embodiment of the present invention, each of the two protruding portions includes a fixing hole, and each of the board bodies includes two concave portions respectively aligned with the two fixing holes. Each of the collision boards further includes two fixing elements respectively coupled to the two fixing holes and in contact with the two concave portions, such that each of the board bodies is fixed between the two protruding portions.

In an embodiment of the present invention, each of the fixing elements includes a setscrew.

In an embodiment of the present invention, the rotating shafts are parallel, and each of the rotating shafts is perpendicular to the transmission shaft.

In an embodiment of the present invention, the length of each of the board bodies is smaller than the distance between two of the adjacent rotating shafts.

In an embodiment of the present invention, the sea wave power generation equipment further includes a power storage device electrically connected to the generator for saving the electrical power generated by the generator.

In an embodiment of the present invention, each of the rotation portions and each of the board bodies are integrally formed as a single piece.

In the aforementioned embodiments of the present invention, since the generator is located on the floating body and the transmission shaft is rotatably connected to the fixing support and the generator, when the transmission shaft rotates in a power generation direction, the generator generates electrical power. When the board bodies are collided with a sea wave in a direction, the board bodies and the ratchet structures can ensure the transmission shaft only rotates in a single direction (i.e., the power generation direction of the generator). Moreover, unavoidable disturbances are located on the sea surface except the direction of the sea wave, and each of the two adjacent sea waves has a timing gap. The board bodies of the collision boards can return to under the sea surface by the ratchet structures due to the gravity or a disturbance reverse to the direction of the sea wave, such that the board bodies can wait for the next collision of the sea wave.

That is, when the board bodies are collided with a sea wave in a direction, each of the pawl portions can hook one of the teeth of one of the ratchet portions, such that the rotating shafts are respectively rotated with the ratchet portions. Simultaneously, the transmission shaft is rotated by the first gear wheels and the second gear wheels, such that the generator generates electrical power. When the board bodies are collided with another sea wave in another direction reverse to the direction, each of the pawl portions slides a portion of the teeth of one of the ratchet portions, such that the rotating shafts do not respectively rotated with the ratchet portions.

### BRIEF DESCRIPTION OF THE DRAWINGS

FIG. 1 is a perspective view of a sea wave power generation equipment of an embodiment of the present invention floating on a sea surface;

FIG. 2 is a side view of a collision board and a ratchet structure shown in FIG. 1;

FIG. 3 is a front view of the collision board and the ratchet structure shown in FIG. 1;

FIG. 4 is a cross sectional view of the sea wave power generation equipment taken along line 4-4′ shown in FIG. 1;

FIG. 5 is a schematic view of the sea wave power generation equipment collided with a sea wave in a direction D3 shown in FIG. 4.

FIG. 6 is a top view of the sea wave power generation equipment collided with the sea wave in the direction D3 shown in FIG. 5;

FIG. 7 is another embodiment of the collision board and the ratchet structure shown in FIG. 2; and

FIG. 8 is another embodiment of the collision board and the ratchet structure shown in FIG. 3.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

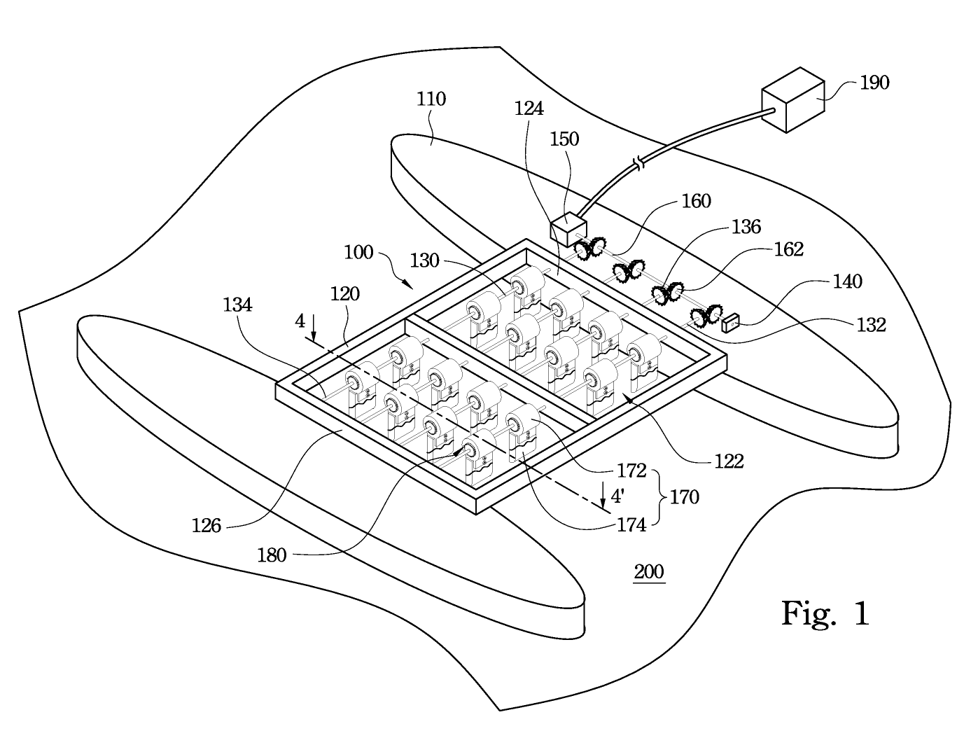

FIG. 1 is a perspective view of a sea wave power generation equipment 100 of an embodiment of the present invention floating on a sea surface 200. The sea wave power generation equipment 100 includes a floating body 110, a frame 120, a plurality of rotating shafts 130, a plurality of first gear wheels 136, at least one fixing base 140, a generator 150, a transmission shaft 160, a plurality of second gear wheels 162, a plurality of collision boards 170, and a plurality of ratchet structures 180. The floating body 110 floats on the sea surface 200. The frame 120 is fixed on the floating body 110 and includes a hollow portion 122, a first side 124, and a second side 126 substantially parallel to the first side 122. The hollow portion 122 is above the sea surface 200. The fixing support 140 and the generator 150 are located on the floating body 110. Each of the rotating shafts 130 includes a first end portion 132 and a second end portion 134, and the first end portion 132 is rotatably connected to the first side 124, and the second end portion 134 is rotatably connected to the second side 126. The first gear wheels 136 are respectively fixed on the first end portions 132. The transmission shaft 160 is rotatably connected to the fixing support 140 and the generator 150. When the transmission shaft 160 rotates in a power generation direction, the generator 150 can generate electrical power. The second gear wheels 162 are fixed on the transmission shaft 160, and each of the second gear wheels 162 is coupled to one of the first gear wheels 136. The rotating shafts 130 are substantially parallel, and each of the rotating shafts 130 is perpendicular to the transmission shaft 160.

The collision boards 170 are located in the hollow portion 122, and each of the collision boards 170 includes a rotation portion 172 and a board body 174. The rotation portion 172 is rotatably sleeved on one of the rotating shafts 130. The board body 174 is fixed on the rotation portion 172, and a portion of the board body 174 is located under the sea surface 200. Each of the ratchet structures 180 is located adjacent to a side of one of the rotation portions 172.

In addition, the sea wave power generation equipment 100 may further include a power storage device 190 electrically connected to the generator 150. The power storage device 190 can save the electrical power generated by the generator 150. The power storage device 190 may be a electric accumulator, and can be located on land or the floating body 110, as long as the power storage device 190 is electrically connected to the generator 150, does not limit the present invention.

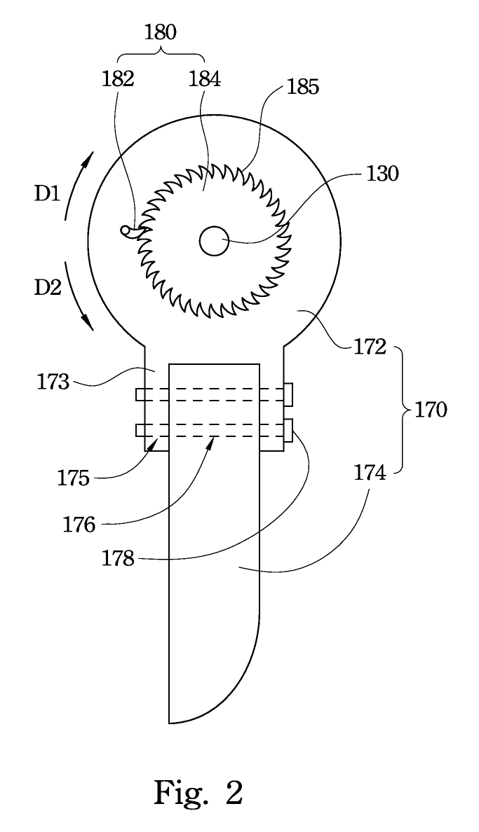

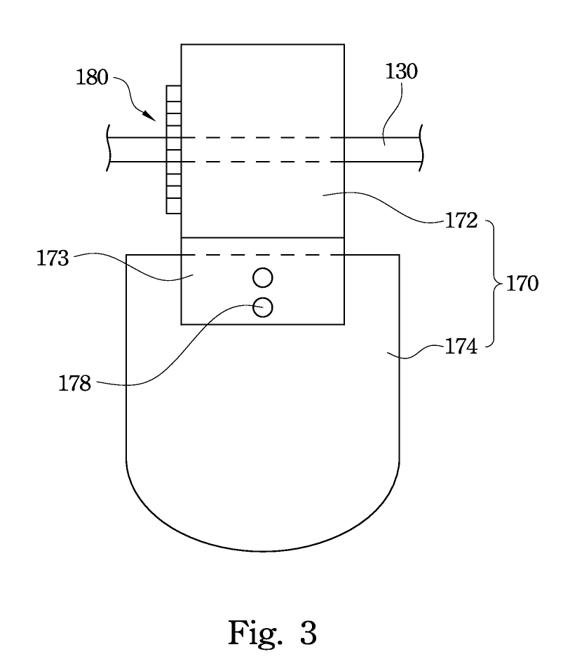

FIG. 2 is a side view of the collision board 170 and the ratchet structure 180 shown in FIG. 1. FIG. 3 is a front view of the collision board 170 and the ratchet structure 180 shown in FIG. 1. As shown in FIG. 2 and FIG. 3, each of the ratchet structures 180 includes a pawl portion 182 and a ratchet portion 184. The pawl portion 182 is located on one of the rotation portions 172. The ratchet portion 184 is fixed on one of the rotating shafts 130 and adjacent to one of the rotation portions 172. Moreover, the ratchet portion 184 includes a plurality of teeth 185 coupled to the pawl portion 182.

In this embodiment, the rotation portion 172 includes two substantially parallel protruding portions 173 to clamp the board body 174. Each of the two protruding portions 173 includes a first fixing hole 175. Each of the board bodies 174 includes a second fixing hole 176, and the two first fixing holes 175 are aligned with the second fixing hole 176. Furthermore, each of the collision boards 170 further includes at least one fixing element 178 coupled to the two first fixing holes 175 and the second fixing hole 176, such that each of the board bodies 174 can be fixed between the two protruding portions 173. Each of the fixing elements 178 may include a screw. The shape of each of the board bodies 174 may be round-shaped, arc-shaped, rectangular shaped, N-sides polygon-shaped, or the combinations thereof. N is a natural number more than or equal to 3.

In other embodiments, the board body 174 may be fixed on the rotation portion 172 by other fixing methods. For example, each of the rotation portions 172 and each of the board bodies 174 may be integrally formed as a single piece in accordance with requirements of designers.

In use, when the rotation portion 172 is rotated in a direction D1, the pawl portion 182 can hook one of the teeth 185 of the ratchet portion 184, such that the rotating shaft 130 is rotated with the ratchet portion 184. Moreover, when the rotation portion 172 is rotated in a direction D2, the pawl portion 182 cannot hook the teeth 185 of the ratchet portion 184 and only slides a portion of the teeth 185 of the ratchet portion 184. As a result, the ratchet portion 184 cannot rotate, such that the rotating shaft 130 does not be rotated with the ratchet portion 184.

Referring FIG. 1 simultaneously, by the aforementioned arrangement, when the rotation portion 172 rotates in the direction D1, the transmission shaft 160 is rotated in the power generation direction of the generator 150 by the first gear wheels 136 fixed on the rotating shaft 130 and the second gear wheels 162, such that the generator 150 generates electrical power. When the rotation portion 172 rotates in the direction D2, the transmission shaft 160 is motionless and does not rotate in a direction reverse to the power generation direction of the generator 150.

It is to be noted that the connection relationship of the aforementioned elements will not be repeated in the following description, and only aspects related to the situation when the board body 174 is collided with a sea wave will be described.

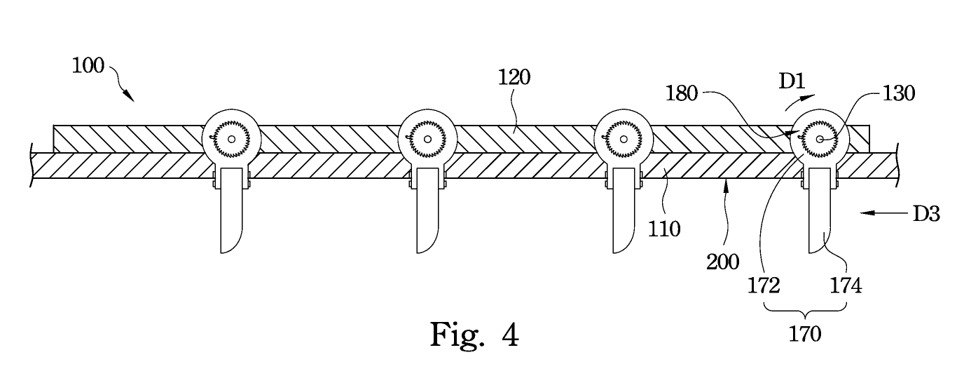

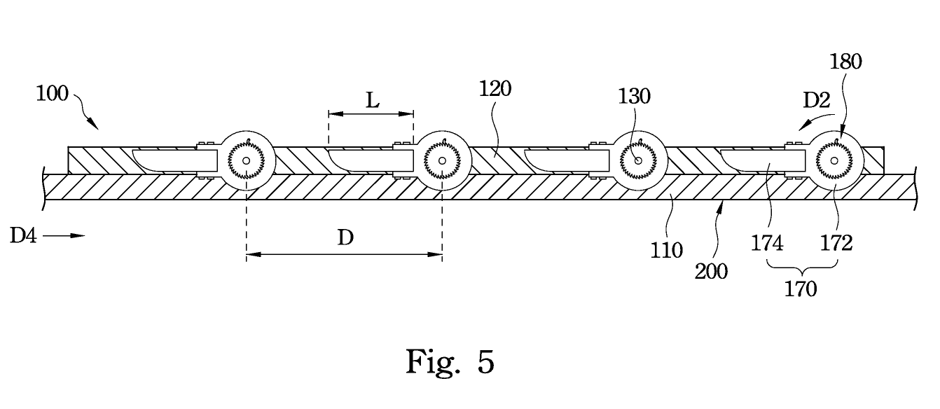

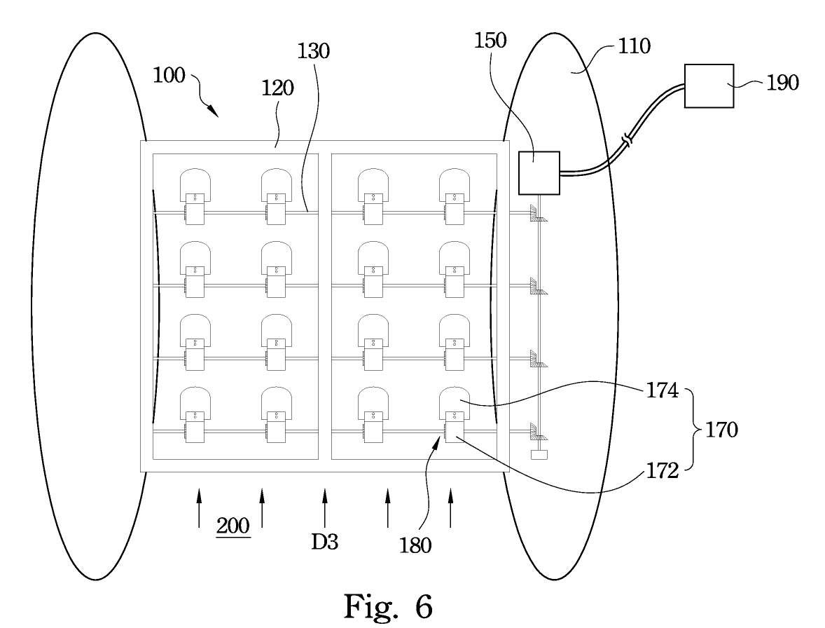

FIG. 4 is a cross sectional view of the sea wave power generation equipment 100 taken along line 4-4′ shown in FIG. 1. As shown in FIG. 2 and FIG. 4, when the board bodies 174 are collided with a sea wave in a direction D3, each of the pawl portions 182 hooks one of the teeth 185 of one of the ratchet portions 184, such that the rotating shafts 130 are respectively rotated in the direction D1 with the ratchet portions 184. The state of the collision boards 170 after rotating in the direction D1 as shown in FIG. 5 and FIG. 6. Consequently, the transmission shaft 160 (see FIG. 1) can be rotated in the power generation direction of the generator 150 (see FIG. 1) by the collision boards 170 and the ratchet structures 180.

FIG. 5 is a schematic view of the sea wave power generation equipment 100 collided with the sea wave in the direction D3 shown in FIG. 4. FIG. 6 is a top view of the sea wave power generation equipment 100 collided with the sea wave in the direction D3 shown in FIG. 5. As shown in FIG. 5 and FIG. 6, in this embodiment, the length L of each of the board bodies 174 is smaller than the distance D between two of the adjacent rotating shafts 130, such that the board body 174 can rotate to a horizontal state. Unavoidable disturbances may be formed on the sea surface 200 except the direction D3 of the sea wave, and each of the two adjacent sea waves has a timing gap. The board bodies 174 of the collision boards 170 can return to under the sea surface 200 in the direction D2 by the ratchet structures 180 due to the gravity or a direction D4 reverse to the direction D3 of the sea wave, such that the board bodies 174 can wait for the next collision of the sea wave in the direction D3.

As shown in FIG. 2 simultaneously, when the board bodies 174 are collided with the sea wave in the direction D4, each of the pawl portions 182 only slides a portion of the teeth 185 of one of the ratchet portions 184, such that the rotating shafts 130 do not respectively rotated with the ratchet portions 184. As a result, the generator 150 does not generate electrical power.

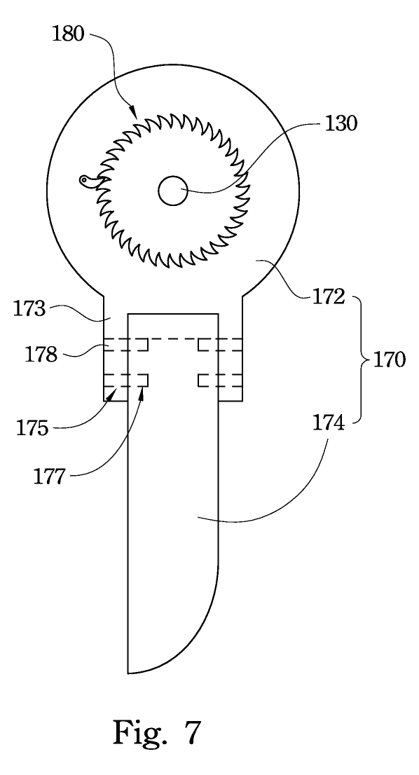

FIG. 7 is another embodiment of the collision board 170 and the ratchet structure 180 shown in FIG. 2. The difference between this embodiment and the aforementioned embodiments is that each of the two protruding portions 173 includes a fixing hole 175, and each of the board bodies 174 includes two concave portions 177 respectively aligned with the two fixing holes 175. Moreover, each of the collision boards 170 further includes two fixing elements 178 respectively coupled to the two fixing holes 175 and in contact with the two concave portions 177, such that each of the board bodies 174 is fixed between the two protruding portions 173. Each of the fixing elements 178 may include a setscrew.

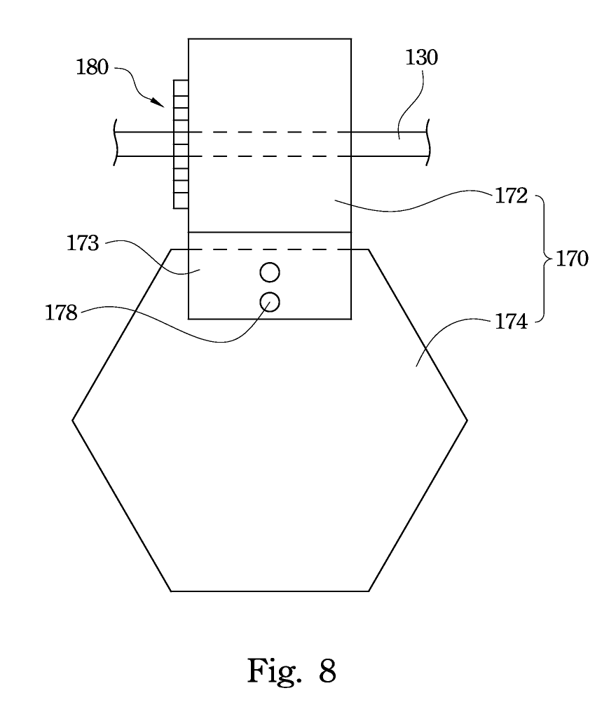

FIG. 8 is another embodiment of the collision board 170 and the ratchet structure 180 shown in FIG. 3. The difference between this embodiment and the aforementioned embodiments is that the shape of the board body 174 may be N-sides polygon-shaped. In this embodiment, N is equal to 6.

Compared with a conventional sea wave power generation equipment, the structure of the sea wave power generation equipment of the present invention is simple and the sea wave power generation equipment is assembled easily. Therefore the material costs can be reduced. Furthermore, since the sea wave power generation equipment floats on the sea surface, managers do not need to dive into water to assemble or repair the sea wave power generation equipments. As a result, the labor cost can be reduced. Since the generator is located on the floating body and the transmission shaft is rotatably connected to the fixing support and the generator, when the transmission shaft rotates in a power generation direction, the generator generates electrical power. When the board bodies are collided with a sea wave in a direction, the board bodies and the ratchet structures can ensure the transmission shaft only rotates in a single direction (i.e., the power generation direction of the generator). In addition, unavoidable disturbances are formed on the sea surface except the direction of the sea wave, and each of the two adjacent sea waves have a timing gap. The board bodies of the collision boards can return to under the sea surface by the ratchet structures due to the gravity or a disturbance reverse to the direction of the sea wave, such that the board bodies can wait for the next collision of the sea wave.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A sea wave power generation equipment comprising:
a floating body floating on a sea surface;
a frame fixed on the floating body and comprising a hollow portion, a first side, and a second side parallel to the first side, wherein the hollow portion is above the sea surface;
a plurality of rotating shafts, each of the rotating shafts comprising a first end portion and a second end portion, and the first end portion is rotatably connected to the first side, wherein the second end portion is rotatably connected to the second side;
a plurality of first gear wheels respectively fixed on the first end portions;
at least one fixing support located on the floating body;
a generator located on the floating body;
a transmission shaft rotatably connected to the fixing support and the generator;
a plurality of second gear wheels fixed on the transmission shaft, each of the second gear wheels being coupled to one of the first gear wheels;
a plurality of collision boards located in the hollow portion, each of the collision boards comprising:
a rotation portion rotatably sleeved on one of the rotating shafts; and
a board body fixed on the rotation portion, wherein a portion of the board body is located under the sea surface; and
a plurality of ratchet structures, each of the ratchet structures comprising:
a pawl portion located on one of the rotation portions; and
a ratchet portion fixed on one of the rotating shafts and adjacent to one of the rotation portions and comprising a plurality of teeth coupled to the pawl portion;
when the board bodies are collided with a sea wave in a direction, each of the pawl portions hooks one of the teeth of one of the ratchet portions, such that the respective rotating shafts are correspondingly rotated with the respective ratchet portions, and the transmission shaft is rotated by the first gear wheels and the second gear wheels, such that the generator generates electrical power, when the board bodies are collided with another sea wave in another direction reverse to the direction, each of the pawl portions slides a portion of the teeth of one of the ratchet portions, such that the rotating shafts do not rotated with the ratchet portions.

2. The sea wave power generation equipment as claimed in claim 1, wherein the rotation portion comprises two parallel protruding portions for clamping the board body.

3. The sea wave power generation equipment as claimed in claim 2, wherein each of the two protruding portions comprises a first fixing hole; each of the board bodies comprises a second fixing hole; the two first fixing holes are aligned with the second fixing hole; and each of the collision boards further comprises:
at least one fixing element coupled to the two first fixing holes and the second fixing hole, such that each of the board bodies is fixed between the two protruding portions.

4. The sea wave power generation equipment as claimed in claim 3, wherein each of the fixing elements comprises a screw.

5. The sea wave power generation equipment as claimed in claim 2, wherein each of the two protruding portions comprises a fixing hole; each of the board bodies comprises two concave portions respectively aligned with the two fixing holes; and each of the collision boards further comprises:
two fixing elements respectively coupled to the two fixing holes and in contact with the two concave portions, such that each of the board bodies is fixed between the two protruding portions.

6. The sea wave power generation equipment as claimed in claim 5, wherein each of the fixing elements comprises a setscrew.

7. The sea wave power generation equipment as claimed in claim 1, wherein the rotating shafts are parallel, and each of the rotating shafts is perpendicular to the transmission shaft.

8. The sea wave power generation equipment as claimed in claim 1, wherein the length of each of the board bodies is smaller than the distance between two of the adjacent rotating shafts.

9. The sea wave power generation equipment as claimed in claim 1, further comprising:
a power storage device electrically connected to the generator for saving the electrical power generated by the generator.

10. The sea wave power generation equipment as claimed in claim 1, wherein each of the rotation portions and each of the board bodies are integrally formed as a single piece.
